(19) United States
(12) Patent Application Publication
(10) Pub. No.: US 2007/0056519 A1
(43) Pub. Date: Mar. 15, 2007

(54) Hanging birdfeeder, birdbath and planter

(76) Inventor: Sally S. Palmer, Savannah, GA (US)

Correspondence Address: LITMAN LAW OFFICES, LTD, PO BOX 15035, CRYSTAL CITY STATION, ARLINGTON, VA, 22215, US

(21) Appl. No.: 11/519,841

(22) Filed: Sep. 13, 2006

Related U.S. Application Data
(60) Provisional application No. 60/717,025, filed on Sep. 15, 2005.

(51) Int. Cl. A01K 61/02

(52) U.S. Cl. 119/57.8; 119/69.5

(57) ABSTRACT

A hanging birdfeeder, birdbath and planter includes a lower container adapted to house a plant(s). An intermediate tray contains water and functions as a birdbath. An upper tray contains birdseed and functions as a feeder. A system of chains and hooks is employed to suspend the container and trays from a structural support such as a post, tree limb or porch ceiling and the like. It is recommended that the suspension height is at least five feet to protect the birds from predators. In a second embodiment a pair of ring members is utilized to support the bath and feed trays. The used water from the bath tray can be employed to water and fertilize the plant.

### CROSS-REFERENCE TO RELATED APPLICATION

This application claims the benefit of U.S. Provisional Patent Application Ser. No. 60/717,025, filed Sep. 15, 2005.

### BACKGROUND OF THE INVENTION

1. Field of the Invention

The present invention generally relates to decorative accessories. More specifically, the present invention is drawn to a feeder and bath for birds that incorporates a hanging plant.

2. Description of the Related Art

Many people are concerned with the well-being of wild birds and provide baths and feeders to aid the avian denizens in securing water and food. The baths and feeders often become a focal point of the yard or area where they are located. It would certainly be a boon if the feeders and baths could be improved in a manner to make the feeders and baths more aesthetically pleasing for householders, gardeners, bird-watchers, etc. Thus, an all-in-one hanging birdfeeder, birdbath and planter which solves the aforementioned problem is desired.

There are many combination birdfeeder and birdbath structures disclosed in the related art. A few of these structures also incorporate means for including plants. Pertinent examples of these structures are cited and identified in the accompanying IDS. However, none of the cited and identified related art, taken either singly or in combination, is seen to disclose a hanging birdfeeder, birdbath and planter combination as will subsequently be described and claimed in the instant invention.

### SUMMARY OF THE INVENTION

The hanging birdfeeder, birdbath and planter of the present invention includes a lower container adapted to house a plant(s). An intermediate tray contains water and functions as a birdbath. An upper tray contains birdseed and functions as a feeder. A system of chains and hooks is employed to suspend the container and trays from a structural support such as a post, tree limb or porch ceiling and the like. It is recommended that the suspension height is at least five feet to protect the birds from predators. In a second embodiment a pair of ring members is utilized to support the bath and feed trays. The used water from the bath tray can be employed to water and fertilize the plant.

Accordingly, the invention presents a unique arrangement wherein a birdfeeder and birdbath are positioned in a small space and wherein a plant provides some cover for the wild birds using the feeder and bath. The plant also lends some “feng shui” to the aesthetics of the arrangement. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a hanging birdfeeder, birdbath and planter according to the present invention.

FIG. 2 is a perspective view of a hanging birdfeeder, birdbath and planter according to the present invention.

FIG. 3 is a partial, perspective view of a hanging birdfeeder according to the present invention.

FIG. 4 is a partial, perspective view of a hanging birdbath according to the present invention.

FIG. 5 is a partial, perspective view of a second embodiment of a hanging birdbath and birdfeeder according to the present invention.

Similar reference characters denote corresponding features consistently throughout the attached drawings.

### DETAILED DESCRIPTION OF THE PREFERRED EMBODIMENTS

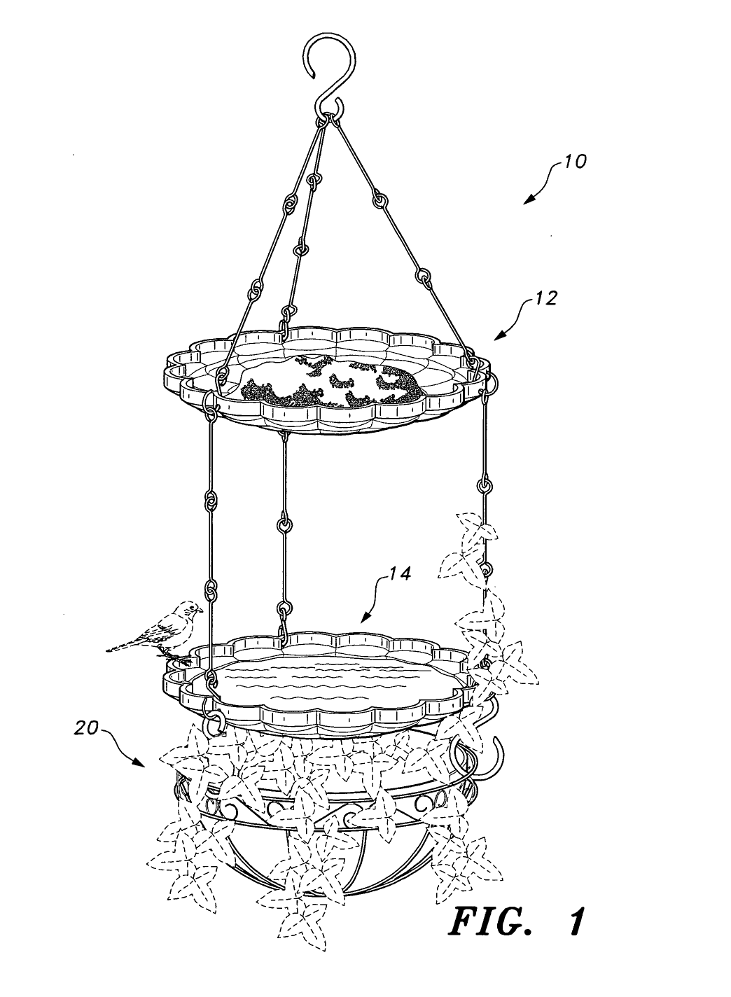

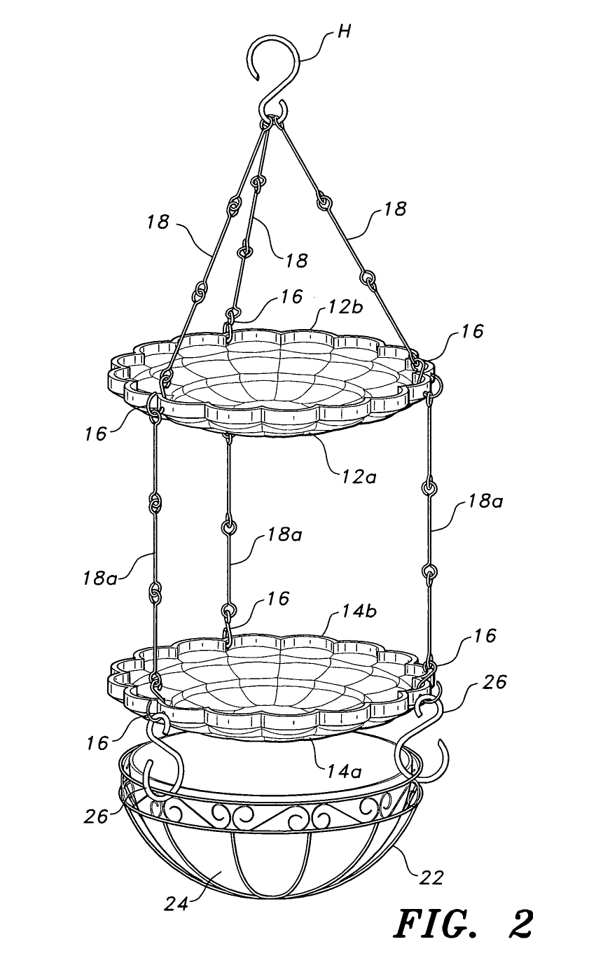

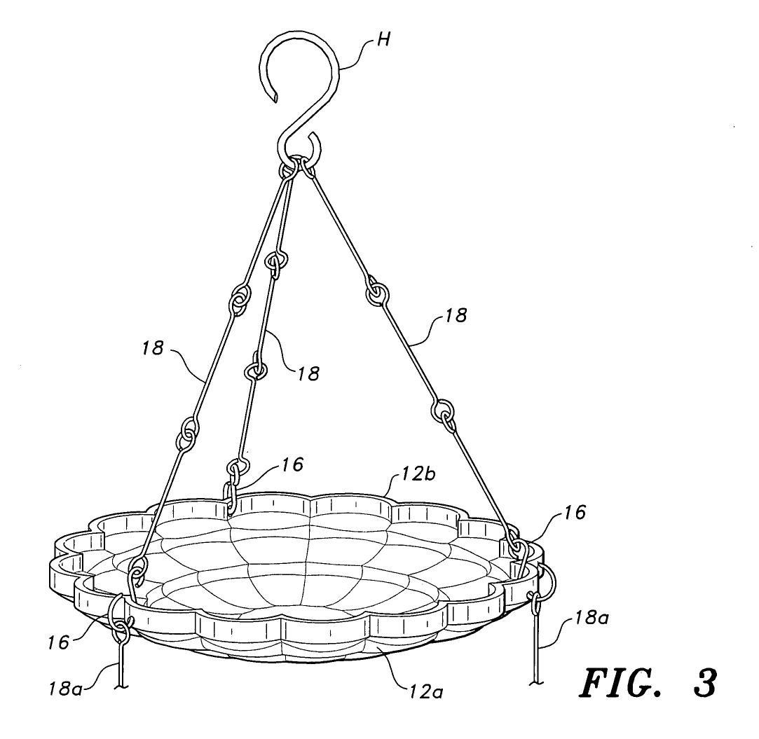

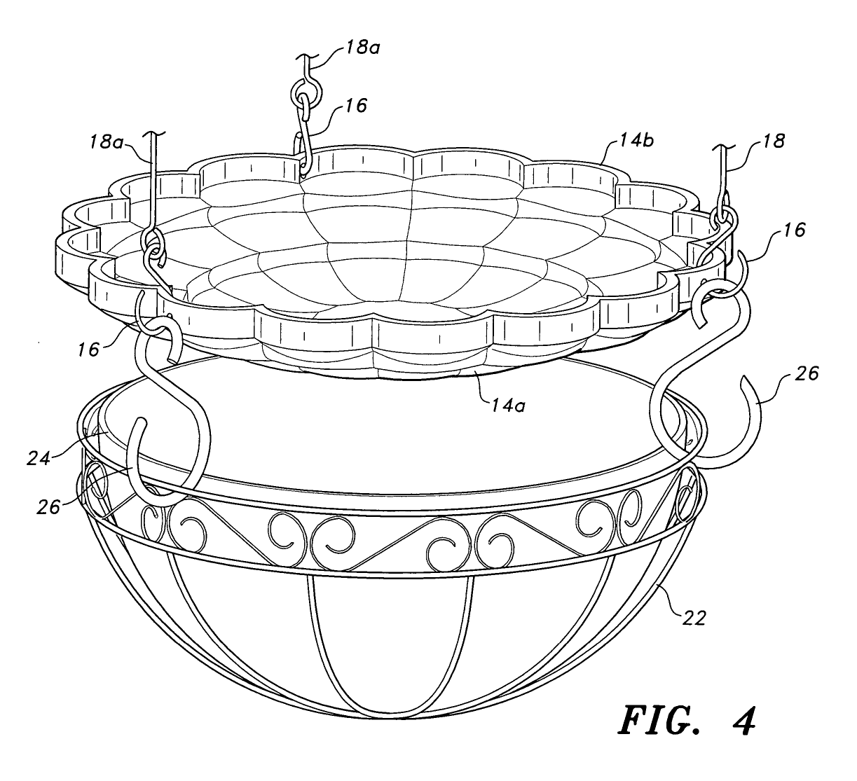

Attention is first directed to FIG. 1-4 wherein the combination feeder, bath and planter of the instant invention is generally indicated at 10. Combination 10 comprises upper and intermediate trays 12 and 14. A planter 20 is positioned below intermediate tray 14. Although not mandatory, it is suggested that the two trays should be identical in configuration and size for easy interchange. The trays can be fabricated from any suitable rigid material (glass, plastic, metal, wood, etc.). Although illustrated as circular, it should be recognized that the trays may be fabricated in other configurations. Each tray has a respective imperforate bottom 12a, 14a and respective circumferential rims 12b, 14b. Respective openings are evenly spaced around the perimeter of rims 12b, 14b. The openings are adapted to retain hooks 16 therein. Plural conventional chains 18 are employed in hooks 16 to suspend the upper tray 12 from a supporting structure (not shown) via an S-hook H or the like. Similar chains 18a suspend intermediate tray 14 from upper tray 12. Planter 20 is positioned immediately below intermediate tray 14. Planter 20 comprises a wire basket 22, which basket contains a fiber liner 24 therein. Hooks 26 are utilized to suspend planter 20 beneath tray 14. The diameter of the planter is approximately the same as the diameter of the trays. Though not mandatory, it is suggested that the trays have a diameter between 10 and twenty inches and a depth of approximately 2 inches. It is important that the trays are easily removable for cleaning. As indicated above, upper tray 12 is the feeder tray and will contain birdseed. Intermediate tray 14 will contain water and functions as a birdbath. It is recommended that tray 14 is positioned approximately 2 inches above planter 20 and that tray 12 is approximately between 15 to 18 inches above tray 14.

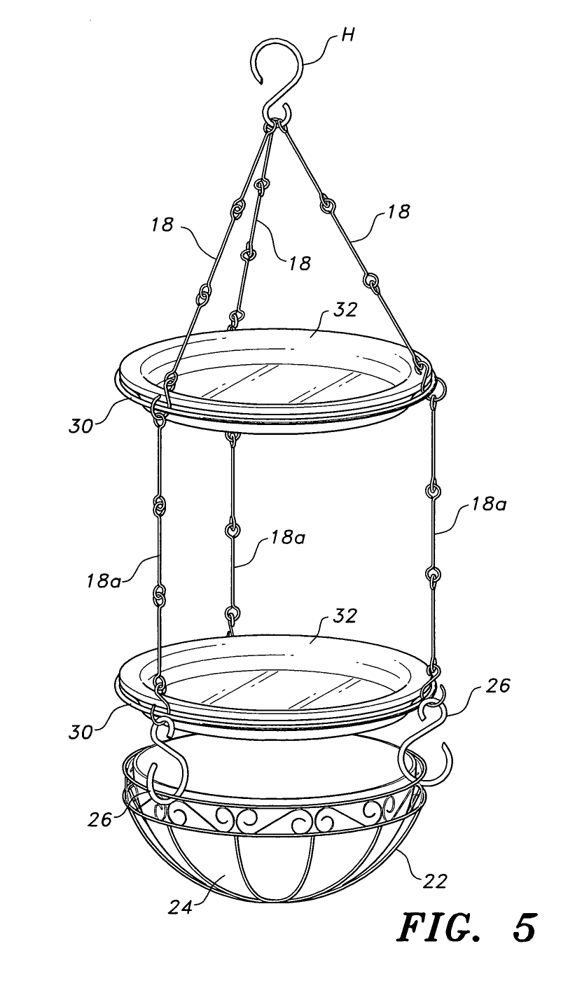

In a second embodiment of the invention, as illustrated in FIG. 5, respective ring members 30 support trays 32 therein. Trays 32 are configured with a circumferential lip designed to rest on a respective ring member. Trays 32 are also identical in size and configuration. Ring members 30 are supported from hooks 16. Rings 30 may be provided with notches or brackets if desired to keep the chains stationary and prevent the hooks from damaging the trays. The instant embodiment affords an even more easily removal of the trays.

It is to be understood that the present invention is not limited to the embodiments described above, but encompasses any and all embodiments within the scope of the following claims.

I claim:

1. A hanging birdfeeder, birdbath and planter, comprising:
a container, said container housing a plant;
a birdbath tray suspended directly above said plant container, said birdbath tray containing water;
structure for suspending birdbath tray directly above said plant container;
a birdfeeder tray suspended directly above said birdbath tray, said birdfeeder tray containing birdseed; and
structure for suspending said birdfeeder tray directly above said birdbath tray.

2. The hanging birdfeeder, birdbath and planter according to claim 1, wherein said birdbath tray and said birdfeeder tray are identical in size and configuration.

3. The hanging birdfeeder, birdbath and planter according to claim 1, wherein said birdfeeder tray and said birdbath tray have respective circumferential rims and wherein openings are disposed in each respective circumferential rim.

4. The hanging birdfeeder, birdbath and planter according to claim 1, wherein said birdfeeder tray and said birdbath tray have respective bottom walls and wherein each respective bottom wall is imperforate.

5. The hanging birdfeeder, birdbath and planter according to claim 1, wherein said plant container includes a wire basket having a fiber liner therein.

6. The hanging birdfeeder, birdbath and planter according to claim 1, wherein said structure for suspending said birdbath tray directly above said plant container includes an array of hooks.

7. The hanging birdfeeder, birdbath and planter according to claim 1, wherein said structure for suspending said birdfeeder tray directly above said birdbath tray includes an array of hooks and chains.

8. The hanging birdfeeder, birdbath and planter according to claim 1, wherein said structure for suspending said birdbath tray directly above said plant container and said structure for suspending said birdfeeder tray directly above said birdbath tray includes a pair of ring members.

9. The hanging birdfeeder, birdbath and planter according to claim 8, wherein said birdfeeder tray and said birdbath tray are each positioned on a respective one of said pair of ring members.

10. A hanging birdfeeder, birdbath and planter, comprising:
a container, said container housing a plant;
a birdbath tray suspended directly above said plant container, said birdbath tray containing water;
an array of hooks for suspending birdbath tray directly above said plant container;
a birdfeeder tray suspended directly above said birdbath tray, said birdfeeder tray containing birdseed; and
an array of hooks and chains for suspending said birdfeeder tray directly above said birdbath tray.

11. The hanging birdfeeder, birdbath and planter according to claim 10, including a pair of ring members and wherein said birdfeeder tray and said birdbath tray are each positioned on a respective one of said pair of ring members.

12. The hanging birdfeeder, birdbath and planter according to claim 10, wherein said birdbath tray and said birdfeeder tray are identical in size and configuration.

13. The hanging birdfeeder, birdbath and planter according to claim 10, wherein said birdfeeder tray and said birdbath tray have respective circumferential rims and wherein openings are disposed in each respective circumferential rim for retaining the respective hooks.

14. The hanging birdfeeder, birdbath and planter according to claim 10, wherein said birdfeeder tray and said birdbath tray have respective bottom walls and wherein each respective bottom wall is imperforate.

15. The hanging birdfeeder, birdbath and planter according to claim 10, wherein said plant container includes a wire basket having a fiber liner therein.
